(19) United States
(12) Patent Application Publication
(10) Pub. No.: US 2014/0312238 A1
(43) Pub. Date: Oct. 23, 2014

(54) FLEXIBLE CONNECTORS FOR PET DETECTORS

(71) Applicant: KONINKLIJKE PHILIPS N.V., EINDHOVEN (NL)

(72) Inventors: Jinling Liu, Solon, OH (US); Bjoern Weissler, Aachen (DE); Steven R. Martin, Chagrin Falls, OH (US); Volkmar Schulz, Wuerselen (DE); Pierre Klaus Gebhardt, Aachen (DE); Peter Michael Jakob Dueppernbecker, Aachen (DE); Wolfgang Renz, Aldenhoven (DE)

(21) Appl. No.: 14/363,349

(22) PCT Filed: Dec. 19, 2012
(86) PCT No.: PCT/IB2012/057482

§ 371 Date: Jun. 6, 2014

Related U.S. Application Data
(60) Provisional application No. 61/580,438, filed on Dec. 27, 2011.

(51) Int. Cl. G01T 1/17

(52) U.S. Cl. CPC G01T 1/17
USPC 250/363.03; 250/366; 29/825

(57) ABSTRACT

A PET or SPECT radiation detector module (50) includes an array of detectors (54, 58) and their associated processing circuitry are connected by a flexible cable having releasable connectors. A method of mounting and dismounting includes mounting a radiation detector array in a support structure in a diagnostic scanner, connecting one end of a flexible connector to the detector array, and connecting the other end of the flexible connector to its associated circuitry.

The present application relates to diagnostic imaging systems and methods. It finds particular application to positron emission tomography (PET) systems with a secondary imaging modality, examples of which include computed tomography (CT), magnetic resonance (MR) imaging, or single-photon emission computed tomography (SPECT). The following also finds application to stand-alone PET or SPECT scanners.

Solid-state PET detectors are usually made of scintillator crystals coupled to an array of detector diodes on a Printed Circuit Board (PCB). This PCB then plugs into other PCBs of the same dimensions to form a detector stack. This detector stack, sometimes called a tile, is then plugged into a bigger PCB which holds multiple stacks. This larger PCB and its accompanying stacks or tiles form a detector module. Currently, the detector stacks plug into the larger PCB using rigid connectors, which create several design challenges.

Because connections of the individual PCBs and the connection of the detector stack to the larger PCB is rigid, the tolerances of the connectors add up and can affect the position of the PET detectors. This rigid mounting of the multiple stacks to its associated PCB can also make dismounting the detector difficult. Because detectors are often mounted in an abutting configuration having more than 2×2 tiles (e.g. 2×3 or 4×3), not all sides of the detectors are accessible. In a 4×3 configuration, there are two tiles with no accessible sides. When dismounting a detector with only one exposed side, the detector can be torqued by only having force applied to one side, causing bending and potential damage to the circuitry or detector crystals.

The rigid mounting also makes cooling difficult, both in that it is difficult to route the cooling through the tight clearances created by the rigid connector and in that more volume must have dry air circulated through it. Dry air is used in the volume containing the detector to prevent condensation when the detector is cooled below room temperature. The rest of the circuitry, which is not cooled as much as the detector (perhaps running above room temperature), is rigidly mounted with tight clearances, hence is enclosed in the same volume as the detector. Cooling the whole volume with dry air increases the amount of cooled, dry air which is supplied.

The rigid mounting can also, for smaller bore PET scanners, increase the depth of interaction (DOI) problem. The more rows of detector-modules that are mounted in the same plane, the greater the number of detectors that do not face perpendicular to the path of the gamma-rays, which are generally radiating from near a center of the bore.

The rigid mounting can also conduct vibration. If the PET detector is used with a secondary imaging system such as, for example, magnetic resonance imaging, eddy currents induced in electrically conductive plates can cause vibration which is mechanically communicated to the detector via the rigid mounts.

The present application proposes to address these problems with a flexible mounting or connection. In accordance with one embodiment, flexible connectors are used to mount the solid state tile stacks. In another embodiment, a solid-state PET detector connected with a flexible detector is mounted in a cap providing mechanical support.

According to one aspect, a radiation detector module is disclosed which includes an array of radiation detectors which generate signals in response to receiving radiation events. Associated processing circuitry processes these signals. A flexible connector connects the radiation detector to some of the associated processing circuitry. The flexible connector may have releasable connectors between the connector and the array of radiation detectors and/or the associated processing circuitry. The radiation detector module may have a support structure, possibly a plate with cooling channels, which supports the array of detectors and has apertures to allow the connector to pass through. The module may be in a housing which defines a passage for circulating dry air over the radiation detectors in order to prevent condensation. The support structure has mechanical elements to engage the sides of the detectors to orient the detector elements toward an examination region. The mechanical elements may define wells which receive the radiation detectors. The module also has a support member for mounting the array of detectors to a diagnostic scanner such that each radiation detector is movable relative to the support member, and the flexible connectors extend between each radiation detector of the array of radiation detectors and electronics mounted to the support member.

The radiation detectors may be scintillation crystals optically connected with silicon photomultipliers and/or solid state radiation detectors. The detector modules may be part of a PET scanner having an annular support structure.

According to another embodiment, a method of mounting a radiation detector is disclosed. The method includes mounting a support structure which supports associated processing circuitry to a diagnostic scanner, connecting a first end of a flexible connector to the detector array and connecting a second end of the flexible connector to the associated circuitry. The method may also include flexing the flexible connector to position the detector array. The method may also include mounting the radiation detectors in a mechanical structure which fixes the detectors in an orientation in the scanner. The mechanical structure may define individual wells for each radiation detector of the detector array. The mechanical structure may also be removed, the flexible connector flexed to improve access to a radiation detector, and the flexible connector disconnected from the radiation detector to remove the radiation detector. After a radiation detector has been removed, a replacement radiation detector may be connected with the flexible connector and mounted in the mechanical structure.

The associated circuitry may also be replaced by disconnecting the flexible connector from the associated circuitry, replacing the circuitry, and reconnecting the replacement associated circuitry with the flexible connector.

The method may further include cooling the radiation detectors and passing dry air over the detectors to prevent condensation.

In another embodiment, a nuclear diagnostic imager is disclosed which includes a plurality of modules each having electronics and an array of radiation detectors, an annular structure around an imaging region, and a plurality of detector modules mounted to the annular structure. Each detector module has an array of radiation detectors which generate signals in response to receiving radiation events, associated processing circuitry which processes the signals, and a flexible connector between the radiation detectors and at least some of the associated processing circuitry.

Advantageously, a flexible mounting or connection allows the detectors to be positioned with greater accuracy (more accurate alignment) while the circuit boards can be mounted with less accuracy, making differences in connectors (due to, e.g., soldering) irrelevant.

Still further advantages of the present invention will be appreciated to those of ordinary skill in the art upon reading and understanding the following detailed description.

The invention may take form in various components and arrangements of components, and in various steps and arrangements of steps. The drawings are only for purposes of illustrating the preferred embodiments and are not to be construed as limiting the invention.

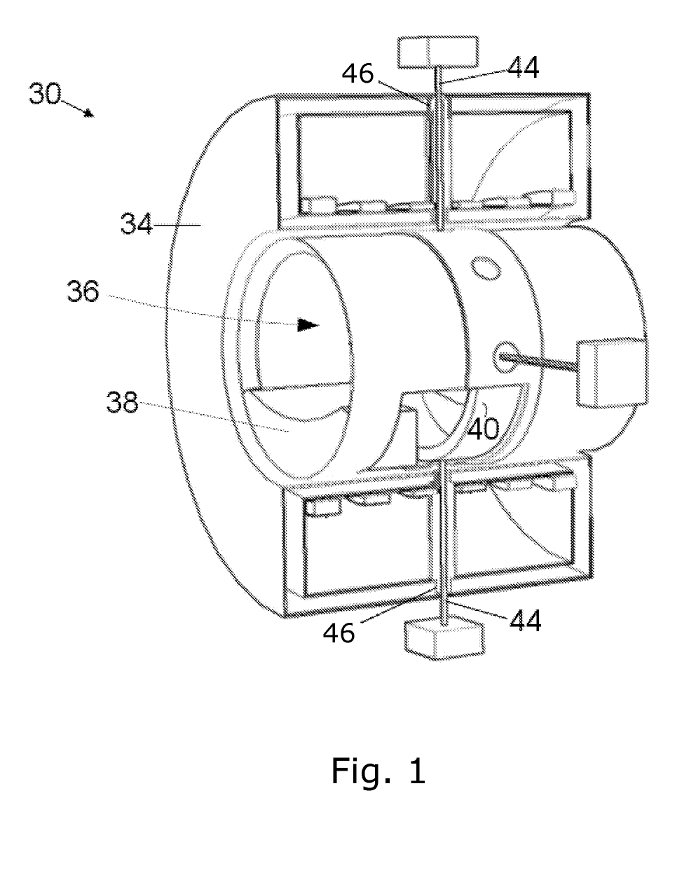

FIG. 1 diagrammatically illustrates a perspective view of a hybrid system having magnetic resonance (MR) scanner and positron emission tomography (PET) scanner.

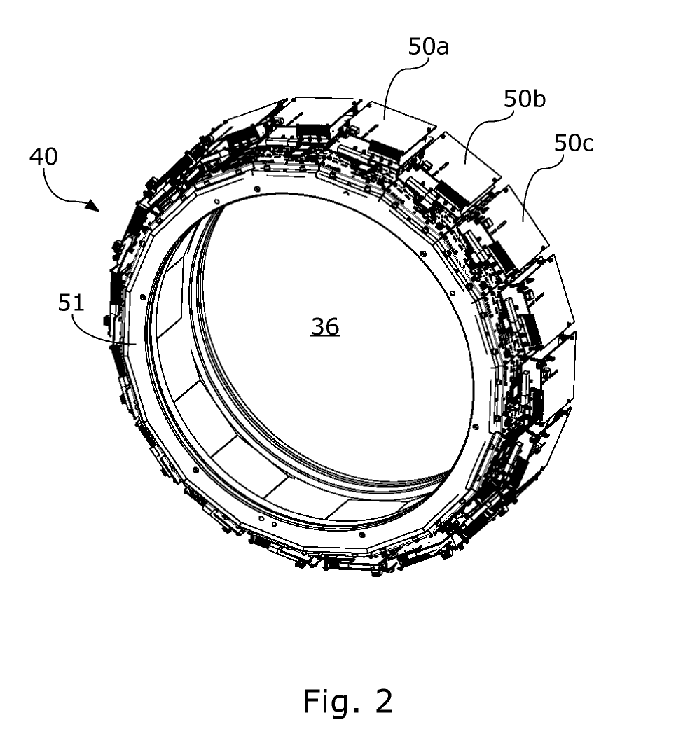

FIG. 2 illustrates a PET detector ring of the hybrid system.

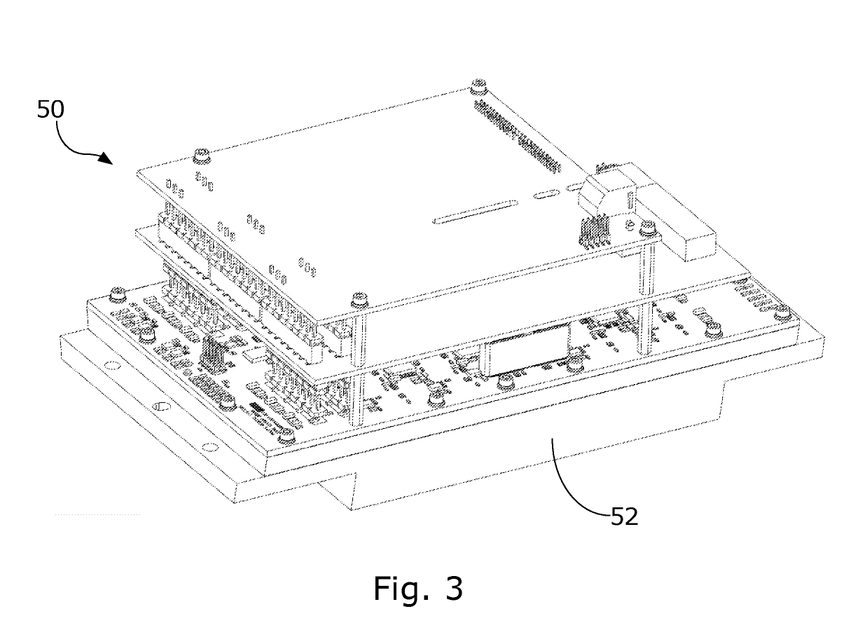

FIG. 3 illustrates an individual PET detector module. In the orientation shown in FIG. 3, down would point into the center of the bore of the image scanning system.

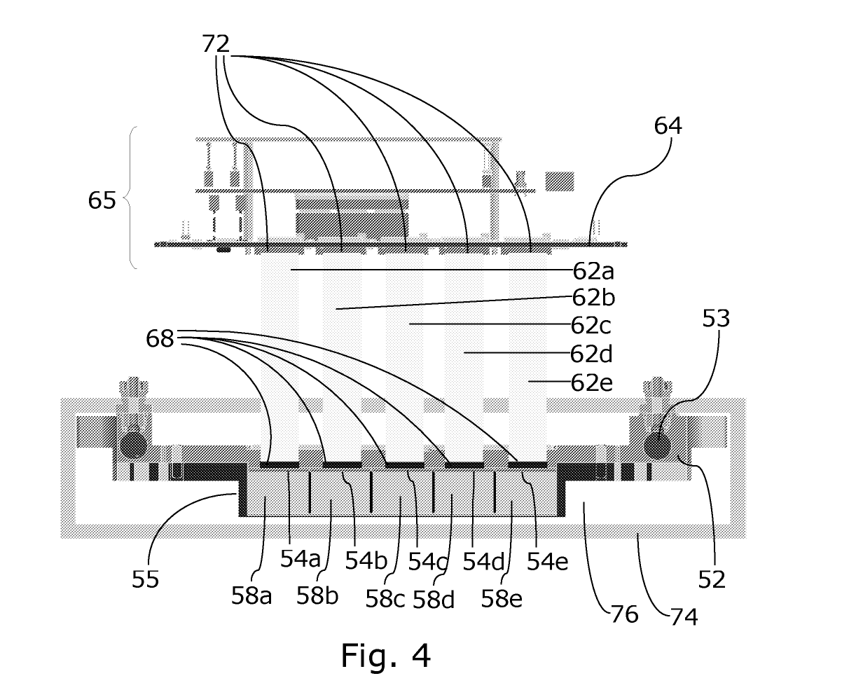

FIG. 4 is a side view of an embodiment in which a detector stack is connected using flexible connectors.

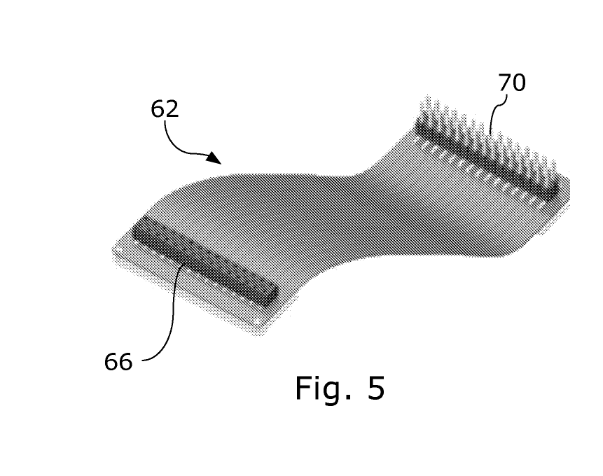

FIG. 5 is a perspective view of a flexible connector.

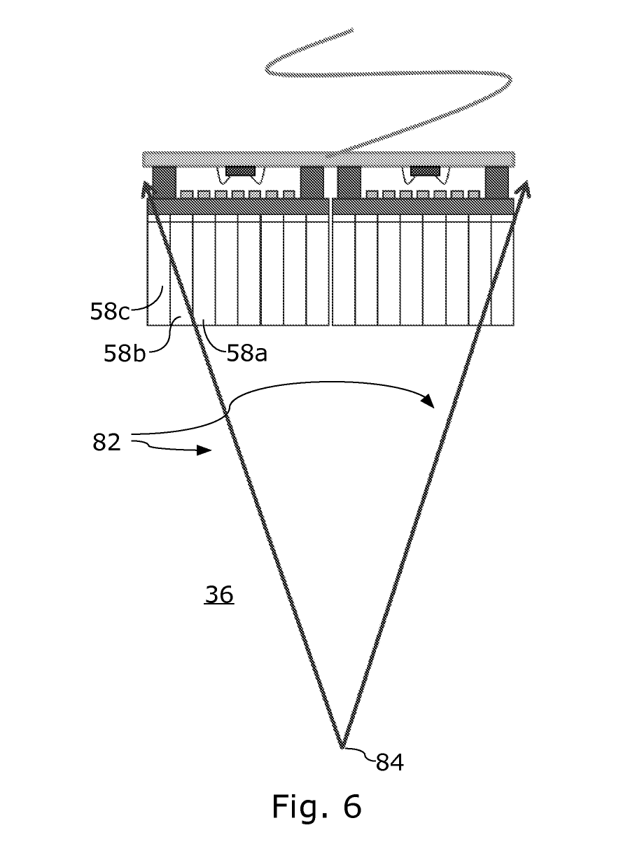

FIG. 6 illustrates depth of interaction problems when detector crystals are rigidly mounted.

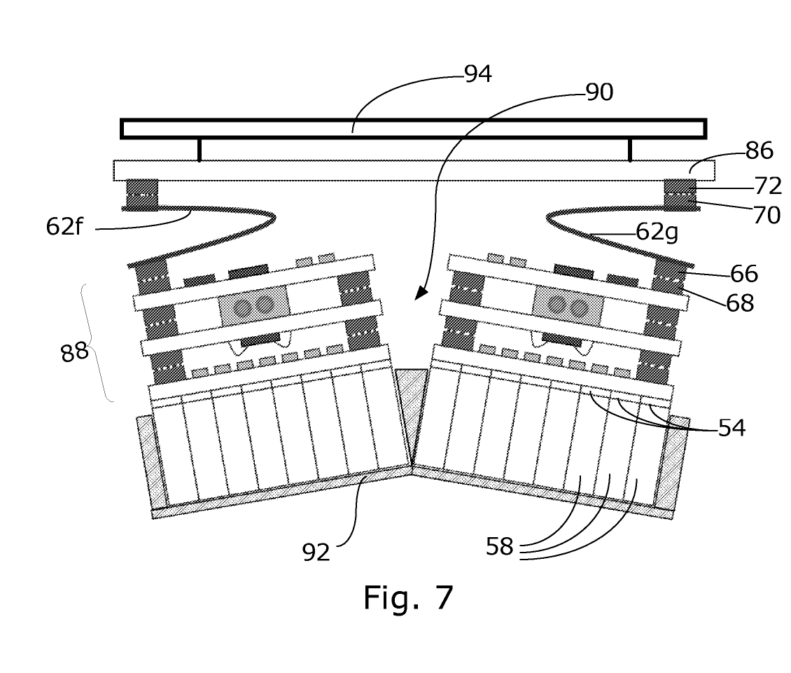

FIG. 7 is a side view illustrating detector crystals and tiles mounted using a flexible connector and a mechanical structure to mechanically position the detector arrays.

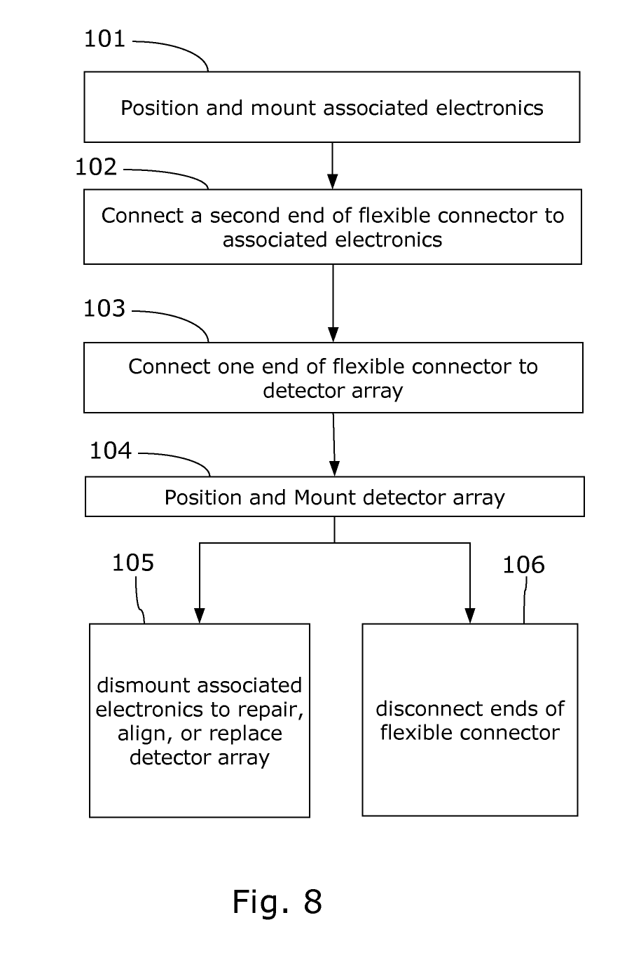

FIG. 8 is a method for installing a crystal and its associated electronics.

With reference to FIG. 1, a hybrid PET/MR scanner 30 has a generally annular PET detection system 40 disposed in the gap or groove in the gradient coil and RF coil of an MR scanner. The generally annular PET detection system 40 and the MR scanner are configured to image a common imaging region 36. The PET detection system 40 is independently supported by mounting members 44 that pass through openings 46 in the magnet housing 34 and between the MR components.

In PET scanning, a pair of gamma rays is produced by a positron annihilation event in the examination region 36 and travel in opposite directions. When the gamma ray strikes the detectors, the location of the struck detector element and the strike time are recorded. A singles processing unit monitors the recorded gamma ray events for single gamma ray events that are not paired with a temporally close event. The temporally close pairs of events define lines of response (LORs), which are reconstructed into a PET image.

A subject support 38 is continuously or stepwise moved relative to the PET gantry 40 to generate list-mode PET data sets that contain events associated with their corresponding location information of the detectors that detected the paired photons. This allows each detector to cover a continuum of longitudinal spatial locations during the scan which results in finer PET acquisition sampling in a longitudinal or z direction. Stepping in short longitudinal increments, e.g. smaller than the longitudinal detector spacing, is also contemplated. The detectors can also be moved circumferentially continuously or in analogous small steps.

FIG. 2 shows the PET detection system 40 from the combined PET/MR scanner or a PET only scanner. The illustrated ring includes 18 modules (three of which are labeled 50a, 50b, and 50c) mounted on an outer surface of a pair of annular rings forming an annular support structure 51. Of course, more or fewer modules may be provided, depending on the diameter of the rings and imaging region 36.

With reference to FIGS. 3 and 4, a detector module 50 is shown. Each detector module 50 includes a cooling and support plate assembly 52 that is cooled by cooling tubes 53. FIG. 4 is a cutaway view of the detector module, showing a plurality of photo detector arrays 54a, 54b, 54c, 54d, and 54e that are supported under the cooling and support plate assembly 52. A plurality of scintillator crystal arrays 58a, 58b, 58c, 58d, and 58e are optically coupled to the photo detector arrays to define a plurality of stacks or tiles which are supported by the cooling and support plate assembly 52. The cooling tubes 53 and the cooling and support plate assembly 52 hold the detector arrays and the scintillation crystals at a substantially constant chilled temperature.

Flexible connectors 62a-62e connect the detector stacks or tiles with downstream processing electronics supported on a circuit board 64, such as a singles processor unit (SPU), analog to digital converter, amplifier, and other associated electronics 65. More specifically, the flexible connector and the detector arrays each include a releasable electrical connector device, such as an array of plugs (one of which is labeled as 66 in FIG. 5) and an array of sockets 68. The circuit board 64 and the flexible connectors include a second set of releasable connection devices, such as pin connectors (one of which is labeled as 70 in FIG. 5) and socket connectors 72. With the connectors removed, the photo detector array and scintillator can be installed, repaired, replaced, and aligned independently of the electronics on the circuit board 64. With one end of the flexible connector 62 connected (attached) to the detector array 54 and the other end of the flexible connector 62 attached to the circuit board 64, the circuit board 64 and other associated electronics, which do not need precisely controlled cooling, are mounted displaced from the cooling plate 52.

The cooling plate 52, the detector array 54, and the crystals 58 are sealed from other components by a housing 74 which provides a light tight and air tight volume 76. The housing may be made of thin aluminum or some other material that does not significantly block the radiation events entering the detector crystals. The thermal load for the system is reduced because the electronics on the circuit board 64, which are not as sensitive to temperature and do not need to be cooled as much as and with the precision as the detector array and scintillator crystal array, are located outside of the cooled volume 76. Only space in the sealed volume 76 containing the detectors is precisely cooled below room temperature. The dry air is circulated through the housing 74 to prevent condensation.

FIG. 5 shows a flexible printed circuit boards with connectors 66 and 70. Advantageously, the illustrated flexible PCB has connectors at both ends, although it is contemplated that the flexible PCB could be made without disconnectable connectors on one or both ends. The flexible PCBs allow movement in all directions, so the crystals can be pushed into position without putting force on the rest of the circuitry, allowing the positioning of the detector crystals to be done with as much accuracy as possible to increase image resolution. The flexible PCB allows the position of the detector stack to be independent of the positioning of the circuit board 64.

The flexible connector 62 allows the detector crystals 58 and photodetectors 54 to be installed and positioned independently of the associated electronics 55. Once the stacks are installed, the flexible connector(s) 62 are attached inside the cooled volume and then exit the housing 74 and connected to the associated electronics 65 which are located outside of the housing 74, allowing the detectors to be aligned more accurately and decreasing the thermal load.

A PET reconstruction algorithm reconstructs the image based on the LORs that are defined in terms of their end points. If the end points are uncertain or ambiguous, the accuracy of the reconstruction suffers. FIG. 6 depicts a depth of interaction problem which can introduce uncertainty into the endpoint of the LORs. When a gamma ray 82 enters one crystal 58a at a significant angle that passes into a second crystal 58b or even a third crystal 58c, the gamma ray can interact with any of these crystals and scintillate. Each crystal gives a different end point for the LOR. When crystals are mounted with the face of the crystal at an angle substantially perpendicular to a ray from the center 84 of the imaging region 36, the DOI problem is mitigated.

With reference to FIG. 7, in another embodiment, flexible connectors (62f, 62g) allows the crystals 58 to be canted towards the center of imaging region, orienting the face of the crystals perpendicular to the radius of the bore of the PET machine, which decreases the depth of interaction effect. In this embodiment, each tile (or row of tiles of width of one tile) is individually oriented separately from its associated module. Advantageously, there is a slight gap 90 between the detector stacks, facilitating removal of the stacks because both sides of the stack can be accessed, providing room for tools or fingers to access the modules. Because the connectors are flexible, the stacks can be temporarily shifted to increase the gap 90 around the detector to be removed. This is particularly helpful in applications where the stacks are removed frequently, such as in a research environment. In smaller bore machines, cooling may be less of a concern than space and locating the module PCB 86 or other electronics 88 in the cooled volume may be acceptable.

In one embodiment, a mechanical support structure 92 supports and aligns the crystals. In the embodiment shown in FIG. 7, the support structure is a cap that provides support for the crystals and aligns the crystals independently of their associated electronics and module 86. The cap may provide individual wells for the crystals, similar in appearance to an ice-cube tray. Force to hold the crystals in the cap can be provided by a spring (not shown). The spring can be mounted to, for example, a cooling plate for the detector or other support structure. Electronics 88 may still be rigidly mounted to the detector. For example, the detector array 54 is preferably mounted to the crystals 58. The module PCB 86 is also supported by a support structure 94 attached to the diagnostic scanner.

Other types of flexible cables besides flexible PCBs are contemplated. For example and not by way of limitation, a ribbon cable could be used. Other types of detectors are contemplated besides a Silicon Photomultiplier (SiPM) detector coupled with a scintillation crystal. A Cadmium Zinc Telluride (CZT) or other solid state detector is contemplated. A scintillation crystal array coupled with a photomultiplier tube is also contemplated. The detector or the crystal may be pixilated. Anger logic may be used.

A method of mounting the detector crystals includes the steps shown in FIG. 8. In step 101, the detector array is positioned and mounted in the imaging scanner. The alignment is important because the more accurately the position of the detector array is known, the better the imaging scanner's resolution will be. For example, when the stacks are mounted in and positioned by wells in the mechanical support structure 92 of FIG. 7, the position is more certain than when the stacks are positioned by only rigid connectors. In step 102, one end of the flexible connector is attached to the detector array. In step 103, a second end of the flexible connector is connected to the detector array's associated electronics. The associated electronics may in a separate volume from the detector, allowing the volume with the detector to be cooled with dry air without having an increased thermal load from the associated electronics. In step 104, the associated electronics is positioned and mounted. The positioning of the associated electronics is generally not as sensitive as the positioning of the detector array. These steps can be performed in other orders. If the associated electronics need repair, the flexible connector is disconnected and the associated electronics are removed in a step 105. If a detector stack or tile is to be replaced, the detector is dismounted and the flexible connector disconnected in a step 106.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A radiation detector module comprising:
an array of radiation detectors which generate signals in response to receiving radiation events;
associated processing circuitry which processes the signals; and
a flexible connector connected between the radiation detectors and at least some of the associated processing circuitry.

2. The module according to claim 1 further including:
releasable connectors between the flexible connector and at least one of the array of radiation detectors and the associated processing circuitry.

3. The module according to claim 1, further including:
a support structure which supports the array of radiation detectors.

4. The module according to claim 3 wherein the support structure includes a plate which carries channels for cooling fluid, at least one of the flexible connectors and the releasable connectors extend through apertures in the plate.

5. The module according to claim 1, further including:
a housing which defines a passage which circulates dry air over at least the radiation detectors to prevent condensation,

6. The module according to claim 3, wherein the support structure includes;
mechanical elements which engage sides of the array of detector elements which orient the detector elements toward an examinations region.

7. The module according to claim 3, wherein the support structure further includes:
a support member for mounting the array of detectors to a diagnostic scanner, the flexible connectors extending between each radiation detector of the array of radiation detectors and electronics mounted to the support member such that each radiation detector is movable relative to the support member.

8. The module according to claim 7 wherein the support structure further includes:
mechanical elements which engage sides of the array of detector elements which orient the detector elements toward an examination region,

9. The module according to claim 6, wherein the mechanical elements define wells which receive the radiation detectors.

10. The module according to claim 1, wherein the radiation detectors include one of:
scintillation crystals optically connected with silicon photomultipliers; and
solid state radiation detectors.

11. A PET scanner comprising:
an annular support structure;
a plurality of radiation detector modules according to claim 1.

12. A method of mounting a radiation detector array comprising:
mounting a support structure which supports associated processing circuitry to a diagnostic scanner;
connecting a first end of a flexible connector to a detector army;
connecting a second end of the flexible connector to the associated circuitry.

13. The method according to claim 12 further including:
flexing the flexible connector to position the detector array.

14. The method according to claim 13 further including:
mounting the radiation detectors in a mechanical structure which fixes the radiation detectors in a selected orientation in the diagnostic scanner.

15. The method according to claim 14 further including:
removing the mechanical structure;
flexing the flexible connector of a radiation detector to be removed to improve access;
disconnecting the flexible connector from the radiation detector to be removed.

16. The method according to claim 15 further including:
connecting a replacement radiation detector with the flexible connector;
mounting the radiation detector in the mechanical structure.

17. The method according to claim 12, wherein the mechanical structure defines individual wells for each radiation detector of the detector array.

18. The method according to claim 12, further including:
disconnecting the flexible connectors from the associated circuitry;
replacing the associated circuitry; and
reconnecting the flexible connectors to the associated circuitry.

19. The method according to claim 12, further including:
cooling the radiation detectors; and
passing dry air over the detectors to prevent condensation.

20. A nuclear diagnostic imager comprising:
a plurality of modules each including electronics and an array of radiation detectors;
an annular structure around an imaging region; and
a plurality of detector modules mounted to the annular structure, each module including:
an array of radiation detectors which generate signals in response to receiving radiation events, the array of detectors being contained in a housing that forms a cooled volume around the array of radiation detectors;
associated processing circuitry which processes the signals, the associated circuitry being located outside of the cooled volume; and
a flexible connector between the radiation detectors and at least some of the associated processing circuitry which passes through an aperture in the housing.
